(19) United States
(12) Patent Application Publication
(10) Pub. No.: US 2015/0097040 A1
(43) Pub. Date: Apr. 9, 2015

(54) BOOSTER ANTENNA STRUCTURE

(71) Applicant: INFINEON TECHNOLOGIES AG, NEUBIBERG (DE)

(72) Inventors: Stephan Rampetzreiter, Graz (AT); Andreas Woerle, Graz (AT)

(73) Assignee: INFINEON TECHNOLOGIES AG, NEUBIBERG (DE)

(21) Appl. No.: 14/049,331

(22) Filed: Oct. 9, 2013

(51) Int. Cl. G06K 19/077; H01Q 7/00

(52) U.S. Cl. CPC G06K 19/07794; G06K 19/07779; H01Q 7/00
USPC 235/492; 343/867

(57) ABSTRACT

In various embodiments, a booster antenna structure is provided, comprising a chip coupling region; a coil having a conductor forming multiple windings, wherein the coil encloses the chip coupling region substantially completely, wherein the conductor is arranged around the chip coupling region in a crossover-free manner.

### TECHNICAL FIELD

Various embodiments relate to a booster antenna structure.

### BACKGROUND

Chip cards, which are commonly also referred to as smart cards, have become indispensable in our daily lives as they are used in a wide variety of fields, cashless payments or identification being probably the two most prominent examples.

The communication between the chip embedded in common smart cards and a corresponding chip card reader is contact-based, i.e. it takes place via contacts which are exposed on the outside of the smart card. However, when the smart card is used, it needs to be taken out of a purse or a pocket, for example, and brought in contact with corresponding contacts of the smart card reader, which may strike the user as annoying.

An interesting extension which solves this problem is the so-called dual interface smart card, in which the chip, in addition to the conventional contact-based interface, is also able to communicate by means of a contactless interface. The contactless interface of the smart card may have a chip card antenna which is provided within the smart card and connected to the chip. The chip card antenna and the chip can be both arranged on one chip card module. In that case such a miniaturized form of the smart card antenna may be referred to as a chip card module antenna. Regardless of the type of the smart card antenna, it is common practice to connect the chip and/or the chip card module in a dual interface smart card to the dual interface smart card's antenna via soldered connections or conductive paste, i.e. via galvanic contacts.

In electronic payment systems, a working distance of up to 4 cm between the chip card and the reader is required. Fulfilling this specification may prove problematic, since the relatively small area of the chip card module may not be able to accommodate a sufficiently large chip card module antenna which would facilitate wireless communication up to the required distance. In order to improve the wireless communication capability, a further antenna, in addition to chip card module antenna, may be provided in the smart card, namely an amplifier antenna, also referred to as booster antenna. The booster antenna can be provided on or within a separate layer and be contained in the smart card. That separate layer containing the booster antenna can be laminated on the smart card in during its manufacturing.

Chip card antennas which are not located on the chip card module but rather on a layer within the chip card may have a sufficiently large size. In those cases a booster antenna may be omitted. However, in the assembly of finished chip card bodies with chip card modules, the chip card modules need to be milled precisely to ensure that chip card module contact pads come in contact with corresponding contacts of the chip card antenna when put together. The contacts can then be joined together using an adhesive while applying pressure.

The manufacturing process just described is costly and complex. In addition, the contact points between the smart card and the chip card module antenna can suffer from low mechanical robustness. Over time, those contacts can detach from one another during bending and folding, which smart cards can be exposed to in everyday life. In view of this problem the expected life time of a smart card with a chip card antenna may be two years. In general, however, a far greater life time of 10 years, for example, would be desirable, for instance in the case of smart cards for use in connection with governmental facilities, where the conversion or renovation costs are substantial due to the mass of used smart cards.

To avoid the problem of mechanically sensitive galvanic connections between the chip card antenna and the chip or the chip card module, booster antennas may be coupled inductively to the chip card module antennas. Current booster antennas usually extend over the entire area of the chip card, if necessary, also over portions which, for example, are designated for embossing fonts (embossing areas, for example as defined according to the ISO/IEC 7811-1 standard) or for the chip cavity, such that those chip cards may not be compliant with the ISO/IEC standard. So far an optimization of the booster antennas in terms of their electrical parameters is not performed, such that corresponding smart cards are not certified according to the EMVCo standard, for example, which is a global standard for credit and debit cards based on chip card technology.

### SUMMARY

In various embodiments, a booster antenna structure is provided, comprising a chip coupling region; a coil having a conductor forming multiple windings, wherein the coil encloses the chip coupling region substantially completely, wherein the conductor is arranged around the chip coupling region in a crossover-free manner.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a top view of a booster antenna structure according to various embodiments;

FIGS. 2A to 2E show top views of further booster antenna structures according to various embodiments;

FIG. 3 shows an equivalent circuit of a booster antenna structure according to various embodiments together with a coil on module; and

FIG. 4 shows a chip card including the booster antenna structure according to various embodiments and a coil on module.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The booster antenna structure described herein is configured to couple inductively to a coil on module (CoM) chip package provided in a wireless or a dual interface smart card. A joint arrangement of an antenna, for example in the form of a coil, and the chip (e.g. a microchip or a microcontroller) on a smart card module is referred to as CoM chip package (hereinafter, CoM chip package will be simply referred to as CoM). The chip and the chip card module coil as well as possibly other electronic components such as resistors, capacitors and further coils of the CoM which may be provided on the chip card module of a wireless or dual interface smart card represent a resonant circuit which may be operated independently. By making use of inductive coupling between an inductively coupled card coil (ICCC), for example a booster antenna of a smart card, and the CoM, special equipment and rather costly investments may be saved which are usually required for the mechanical-electrical connections in ordinary smart cards between those two entities. The inductive coupling between the smart card chip, for example a RFID chip, and the smart card antenna, for example the booster antenna, may simplify the card manufacturing process and result in better yield and inherently more robust smart cards when compared with conventional smart cards relying on galvanic interconnections between the chip or the chip card module and the chip card antenna.

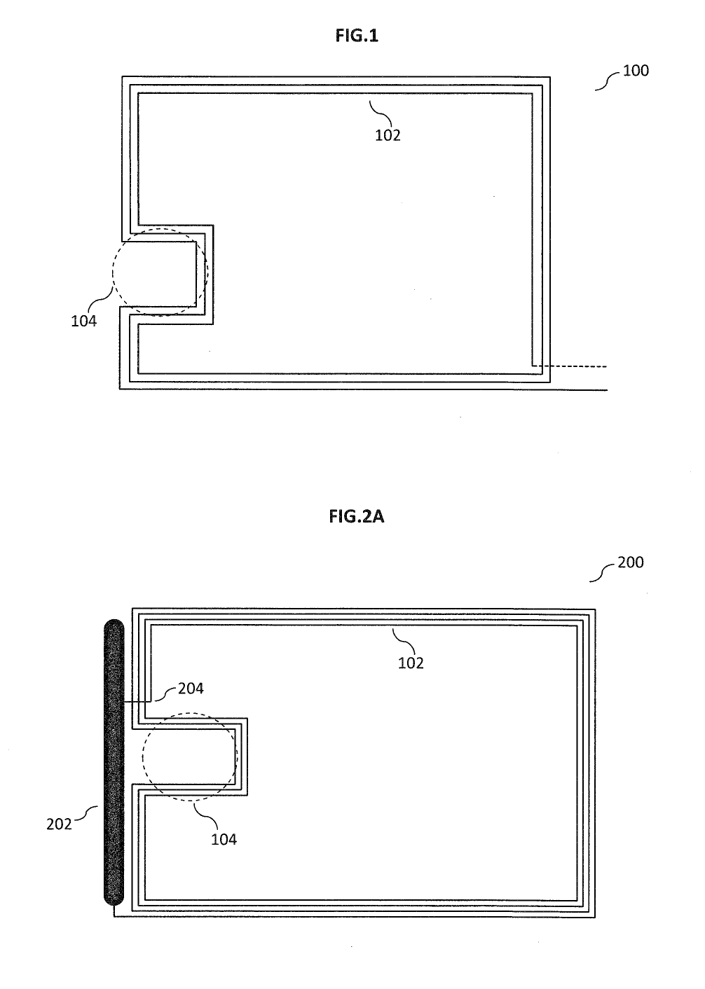

In FIG. 1 a top view of a booster antenna structure 100 is shown. The booster antenna structure 100 may include a coil 102 and a chip coupling region 104. The coil 102 may include a conductor, e.g. an electrically conducing wire or a conductive material, formed into multiple windings. The conductor may be obtained from etching a layer of an electrically conductive material, for example a metallic layer, into a desired geometrical form or simply formed from a metallic or other electrically conductive wire. The chip coupling region 104 may be substantially completely surrounded or enclosed by the conductor, i.e. by a part of the coil 102. Parts of the conductor, i.e. parts of the coil 102, may be arranged adjacent to the chip coupling region 104 in a crossover-free manner. In other words, looking from above (or below) on the booster antenna structure 100 according to various embodiments shown in FIG. 1, the region of the coil 102 around the chip coupling region 104 may be free of intersections or crossings between any two or more windings of the coil 102. With the crossover-free arrangement of the coil 102 within/adjacent to the coupling region 104, a formation of an explicit (coupling) coil wound within/around the coupling region 104 is not required.

The number of windings comprised by the coil 102 and the number of sections of the windings of the coil 102 which form the chip coupling region 104 may be the same or be different from one another. In the embodiment shown in FIG. 1, the chip coupling region 104 is enclosed or surrounded by parts of three windings from three sides, whereas the coil includes four windings. The spacing between the individual windings of the coil 102, even though shown nearly uniform in FIG. 1, may be different and may be used to adjust the coupling coefficient between a CoM which may be placed in the chip coupling region 104 and the booster antenna structure 100 according to various embodiments. The geometrical form of the chip coupling region 104 is not limited to the embodiment shown in FIG. 1. A characterizing feature of the chip coupling region 104 may be that it is surrounded or enclosed by one or more parts of the coil 102 on at least three sides thereof. In order to achieve an good coupling coefficient between the booster antenna structure 104 and the CoM, the chip coupling region 104 and the CoM may have a similar shape, which may, for example, be rectangular or quadratic. In the case of a quadratic or rectangular shape, its one dimension (e.g. a length) may lie in the range from about 1 mm to about 20 mm, for example in the range from about 10 mm to about 20 mm and its other dimension (e.g. a width) may lie in the range from about 1 mm to 20 mm, for example in the range from about 10 mm to about 20 mm. However, other dimensions are possible which may be given by the size of the CoM and/or the desired coupling coefficient, which may be altered by the spacing between the chip card module antenna and the windings of the booster antenna structure according to various embodiments. It is to be noted that the booster antenna structure 100 may include additional electronic elements such as resistors and/or capacitors in order to adjust its electronic properties, for example its coupling coefficient to the CoM or its quality factor.

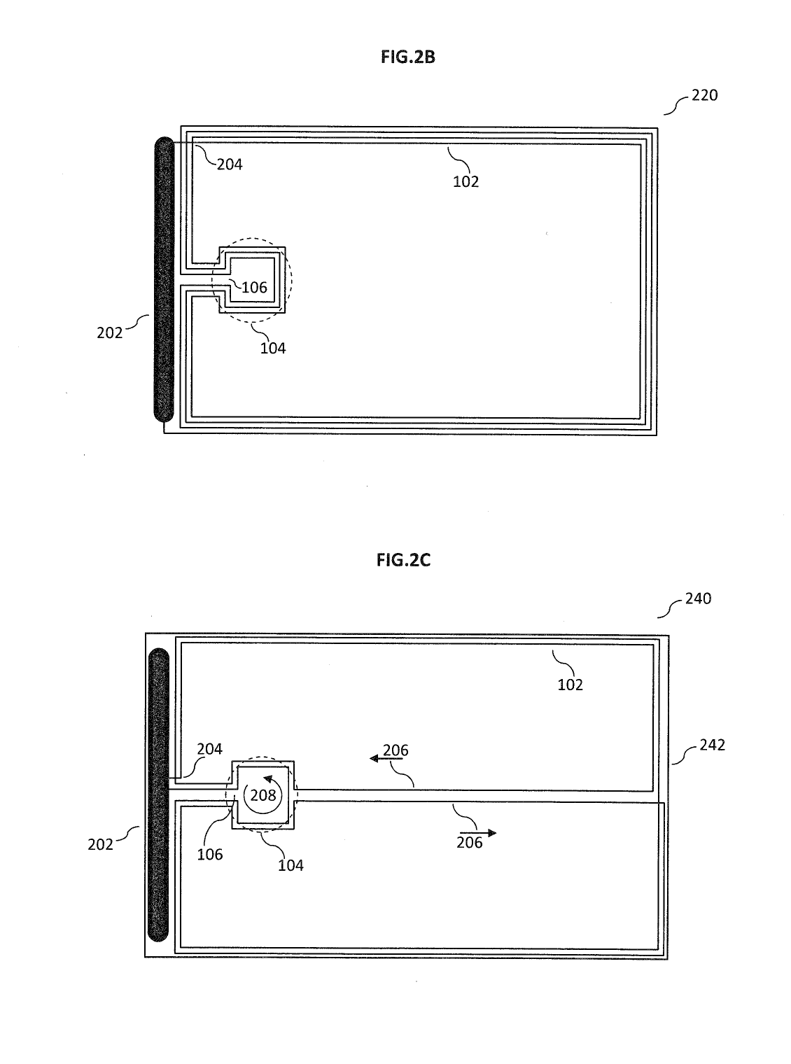

In FIG. 2A a top view of a further embodiment of the booster antenna structure 200 is shown. As its structure is based on to the booster antenna structure 100 shown in FIG. 1, the same elements are labelled with the same reference numbers and their function will not be described again.

The booster antenna structure 200 shown in FIG. 2A includes a capacitive element in the form of a plate capacitor 202. The plate capacitor may include two plate electrodes of which one is shown in FIG. 2A. The other plate electrode one may be arranged underneath the plate electrode shown in FIG. 2A, e.g. on the other side of a substrate or a carrier (not shown in FIG. 2A) on which the booster antenna structure 200 may be arranged. The carrier may include an electrically isolating material, for example a dielectric material such as PVC (polyvinylchloride), which may increase the capacitance of the plate capacitor 202. A connecting part 204 of the coil conductor which seemingly intersects the other three windings of the coil 102 in the top view of the booster antenna structure 200 in FIG. 2A may be arranged on the other side of the carrier (not shown in FIG. 2A) and may be connected to the innermost winding of the coil 102 through an opening the carrier.

In FIG. 2B a top view of a further embodiment of the booster antenna structure 220 is shown. As its structure is similar to the booster antenna structure 200 shown in FIG. 2A, the same elements are labelled with the same reference numbers and their function will not be described again.

The overall structure of the booster antenna structure 220 is similar to the booster antenna structure 200 shown in FIG. 2A. However, the chip coupling region 104 is enclosed or surrounded by parts of the coil 102 from almost all four sides. As the coil conductor is formed into windings continuously coupled to one another, the chip coupling region 104 cannot be completely enclosed by the coil if the conductor is to be arranged around the chip coupling region 104 in a crossover-free manner. Therefore, there is a small gap 106 in the innermost winding and in every other winding arranged outwardly thereof forming the chip coupling region 104. The dimension of the gap 106, however, may be negligible in comparison with the length of the left side of the chip coupling region 104 which may be approximately defined by the side length of the square or rectangle formed by a part of one of the windings of the coil 102 forming the chip coupling region 104.

In FIG. 2C a top view of a further embodiment of the booster antenna structure 240 is shown. As its structure is similar to the booster antenna structure 220 shown in FIG. 2B, the same elements are labelled with the same reference numbers.

The main difference between the embodiment of the booster antenna structure 240 and the one shown in FIG. 2A or in FIG. 2B is that the chip coupling region 104 features a more complex structure. The conductor forming the coil 102, figuratively speaking, arrives from two different sides as compared to the so far discussed embodiments where it arrives just from one side, for example from the left side as shown in the embodiments of the booster antenna structure according to various embodiments shown in FIG. 2A or in FIG. 2B. Furthermore, a possible current flow direction is indicated by arrows 206 and 208. The direction 206, 208 of the current through the coil 102 as such is arbitrary. Assuming a current flow through the coil 102 as indicated by the arrows 206, a circular current flow 208 may be observed flowing around the chip coupling region 104. The innermost coil conductor of the chip coupling region 104 is formed by one continuous section of the coil conductor of one winding of the coil 102. There is a gap 106 on the left side of the chip coupling region 104 between two sections of the coil conductor. The innermost coil conductor of the chip coupling region 104 is surrounded by two separate sections of the coil conductor belonging to a different winding of the coil. There is a gap separating the two coil conductor sections on the left side (mimicking the smaller gap 106 between parts of the innermost coil conductor forming the chip coupling region 104) and a further gap separating the two coil conductor sections on the right side of the chip coupling region 104. The conductor sections of the coil 102 forming the chip coupling region 104 are guided adjacently to the four sides of the chip coupling region 104 in such a manner that the current flow's direction through the conductor in the parts defining the chip coupling region 104 is clockwise or counter-clockwise (in the exemplary embodiment shown in FIG. 2D it is indicated as counter-clockwise by the arrow 208). This results in a seemingly circular current flow 208 around or on the edge of the chip coupling region 104 and entails a magnetic field directed, if the technical current flow direction 206, 208 is assumed, into the plane of paper through the center of the chip coupling region 104. Those two aspects—an arrangement of the conductor of the coil 102 along all four sides of the chip coupling region 104 and uniform direction of current flow around the chip coupling area 104—may lead to an increased magnetic flux within the chip coupling area 104 of the booster antenna structure 240. This may be advantageous with respect to the coupling coefficient between the booster antenna structure according to various embodiments and the CoM. In FIG. 2C, the carrier 242, for example a polymeric layer, is indicated, on which the coil 102 of the booster antenna structure 240 may be arranged. It is to be noted, that both sides of the carrier 242 may be used as surfaces on which elements of the booster antenna structure 240 such as the coil 102 and/or the capacitor 202 or parts thereof or further components may be arranged.

In FIG. 2D a top view of a further embodiment of the booster antenna structure 260 is shown. As its structure is similar to the booster antenna structures shown in FIG. 2A, FIG. 2B or FIG. 2C, the same elements are labelled with the same reference numbers.

The embodiment of the booster antenna structure 260 shown in FIG. 2D features a multi-layered design. The conductor forming the coil 102, as seen in a top view in FIG. 2D, may be arranged or may form two separate layers itself. The section of the conductor forming a first part 262 of the coil 102 of the booster antenna structure 260 may be arranged on or in one layer and the conductor forming a second part 264 of the coil 102 of the booster antenna structure 260 may be arranged on or in a different layer. The two layers may be separated from one another by an insulating layer or material. However, the two layers need not be separate layers as such. The booster antenna structure 260 according to various embodiments may be arranged on a carrier during the manufacturing process which may then be laminated to other layers of a chip card, for example. The first layer may correspond to one surface of the carrier, for example its front side, and the second layer may correspond to the other surface of the carrier, such that the first part 262 of the coil 102 may be arranged on the front side of the carrier, whereas the second part 264 may be arranged on the back side of the carrier. The connecting part 204 and a further connecting part 266 may be seen as interconnections between the first part 262 and the second part 264 of the coil 102. Within/Around the chip coupling region 104, sections of the conductor from both parts 262, 264 of the coil 102 may be arranged. As may be seen in the top view of the exemplary booster antenna structure 260 in FIG. 2D, some sections of the conductor from both parts 262, 264 of the coil 102 may be arranged above one another, i.e. their projections within the plane of paper may be aligned with one another. Therefore, the coupling region 104 may include sections of the conductor in two layers. Such a design may enable increasing the density of the conductor (i.e. number of sections of the conductor) within/adjacent to the coupling region 104. It is to be pointed out that the arrangement of the conductor of the coil 102 around the chip coupling region 104 is crossover-free, as parts of the conductor which may seem as if they were crossing each other in the top view presented in FIG. 2D are actually arranged on different sides/surfaces of a carrier. The term crossover as used in this description, however, refers to crossovers, i.e. parts of the conductor of the coil 102 where one is arranged on top of the other, on the same side/surface of a carrier or a material layer on which the coil 102 may be arranged. As explained above, such a constellation is not present in the booster antenna structure according to various embodiments in FIG. 2D.

In FIG. 2E a top view of a further embodiment of the booster antenna structure 280 is shown. As its structure is similar to the booster antenna structures shown in FIG. 2A, FIG. 2B, FIG. 2C or FIG. 2D, the same elements are labelled with the same reference numbers.

The booster antenna structure 280 shown in FIG. 2E is shows a possible configuration which may be achieved via wire-embedding. In FIG. 2E, the exemplary booster antenna structure 280 is arranged within or on just one layer. The capacitive element 202 from FIGS. 2A to 2D is realized as a line capacitor in the embodiment shown in FIG. 2E, i.e. any two adjacent sections of the conductor forming the coil 102 running along one another may contribute to an overall capacitance. The arrows 206 indicate an exemplary one of the two possible current flow directions through the coil 102. The coil 102 may be provided on one side of the carrier 242, wherein in regions 282 in which parts of the coil 102 cross each other, an isolating layer may be provided between the lower part of the conductor and the higher part of the conductor running above and across the lower part of the conductor in order to prevent a short circuit. The chip coupling region 104 is formed by the coil conductor surrounding the chip coupling region 104 without any intersections or crossovers. The conductor on the left side, the bottom side and the right side of the chip coupling region 104 belongs to one continuous section of the coil conductor, whereas the upper side is formed by a second section of the coil conductor. The first section of the conductor coil is separated from the second section of the conductor coil by two gaps 106. Due to the circular current flow around the center of the chip coupling region 104, a magnetic field 212 is generated directed, if the technical current flow direction 206 is assumed, out of the plane of paper through the center of the chip coupling region 104. The position and the extent of the conductor forming the coil 102 on the carrier 242 as well as its geometrical shape may be adapted to the specific card design. For example, the conductor forming the coil 102 may be formed into a shape which allows for embossing regions as defined by the ISO/IEC 7811 standard and/or regions for openings within the chip card, for example for attaching a fastener such as a chain or a plastic band.

In general, the designs of the booster antenna structure according to various embodiments shown so far in the figures FIG. 2A to FIG. 2E are not be construed as limiting the scope of possible booster antenna structure designs. In particular, the location of the chip coupling region 104 is not limited to the positions depicted in the figures, as it may be freely chosen and thereby adjusted to the specific chip card design. Also, the position of the plate capacitor 202 may differ from the position depicted in the figures and may be also given by the specific chip card design. The plate capacitor 202 is one of very many possible ways to realize a capacitive element. For example, it may be replaced by a line capacitor formed by two sections of the coil conductor running along one another, wherein the capacitance may be varied by the length of that structure or the distance between the sections of the coil conductor, or a plate capacitance with a dielectric in between, wherein the whole structure may be rolled into a spiral.

Overlooking the various exemplary embodiments of the booster antenna structure in FIGS. 2A to 2E it may be seen that the chip coupling region 104 is formed by at least one part of the coil 102 of the booster antenna structure. That at least one part of the coil 102 may be arranged around the chip coupling region 104 (on at least one surface of a corresponding carrier) in a meander-like manner without any crossovers of the conductor. The chip coupling region 104 may be seen as a dedicated or distinct region which features a micro-arrangement of parts of the coil 102 of the booster antenna structure according to various embodiments. The crossover-free arrangement of at least one part of the coil 102 around the chip coupling region 104 may lead to the presence of a passage between an inside and an outside of the chip coupling region 104, for example between the center region of the chip coupling region 104 where a corresponding chip package may be placed and the exterior of the chip coupling region 104. The passage between an inside and an outside of the chip coupling region 104 may be also translated into the fact that there is no dedicated coupling coil which may be coupled in series with the coil 102 forming the booster antenna completely surrounding the chip coupling region 104. Instead, at least one part of the coil 102 may be arranged around the chip coupling region in a crossover-free manner, for example in a meander-like manner and that at least one part of the coil 102 may define the chip coupling region 104.

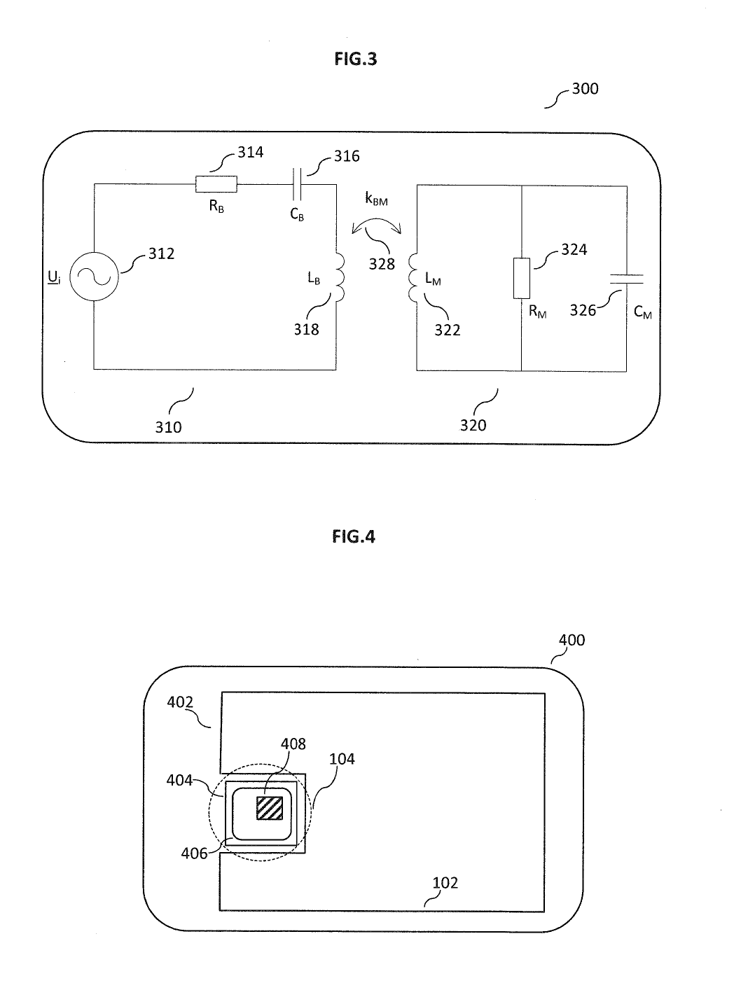

In FIG. 4, a structural view of a chip card 400 is shown. The chip card 400 may include multiple layers or inlays, such as functional layers carrying electronic circuits providing various kinds of functionalities, such as a layer carrying the booster antenna structure according to various embodiments, a layer carrying the CoM, one or more layers carrying a display or other form of interactive means configured to communicate with the user (LEDs and/or OLEDs, for example), stabilizing layers and/or protective cover layers providing a certain haptic and/or visual effect. The chip card body and the individual layers comprised by the chip card 400 may be typically formed of non-conducting materials, such as a PVC material. In FIG. 4, emphasis is put on the booster antenna structure 402 according to various embodiments and the CoM 404, other elements and/or layers are omitted for reasons of clarity. The booster antenna structure 402 according to various embodiments, as shown in FIG. 4, corresponds to the one previously discussed and shown in FIG. 2A. However, any other booster antenna structure according to various embodiments depicted in FIG. 2B, FIG. 2C, FIG. 2D or FIG. 2E may be replaced for the one from FIG. 2A chosen as an example. For reasons of clarity, the coil 102 of the booster antenna structure 402 includes only one winding, which is to be understood as a representation for any number of windings, e.g. 1, 2, 4 as shown in FIG. 2A, or more. A CoM 404 including a chip 408, e.g. a microcontroller chip, and a chip card module antenna 406 (and possibly further electronic components, such as metallic interconnections, resistors, capacitors, coils which have been omitted for reasons of clarity) may be arranged within the chip coupling region 104. In case of a dual interface smart card, the chip 408 may be electrically coupled to contact pads according to ISO/IEC 7816 which may be exposed on the surface of the dual interface smart card. The chip card module antenna 406 is represented by one winding only. As in the case of the coil 102 of the booster antenna structure 402 according to various embodiments, it is to be understood as a representation for any number of windings, e.g. 1, 2, 3, 4, 5, 10 or more.

During contactless operation, i.e. when the chip card 400 which may be a contactless chip card or a dual interface chip card, the CoM may communicate via the booster antenna structure 402 according to various embodiments with a corresponding reader. The antenna coil 406 integrated on the chip card module 404 may transmit and receive data to and from the reader (not shown in FIG. 4) via the chip card antenna, i.e. the booster antenna structure 402, using inductive coupling, i.e. a radio connection. The booster antenna coil 102 as an antenna may be specifically tuned to meet the requirements of the ISO/IEC 14443 or EMVCo 2.0.1 or PayPass v1.1 standards.

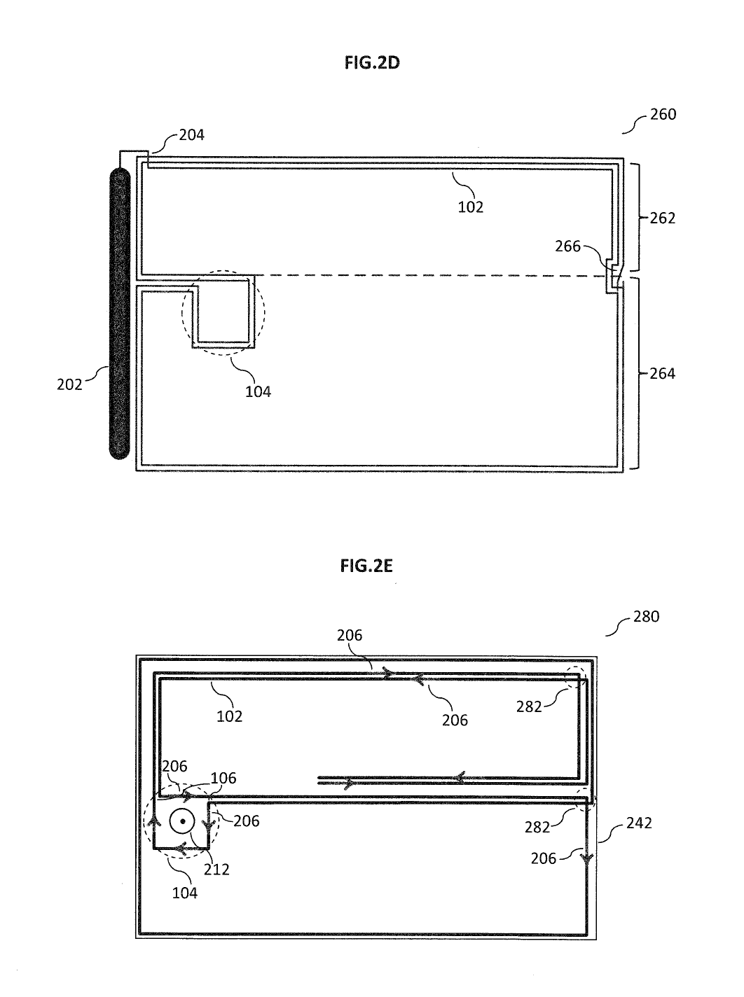

An equivalent circuit of a contactless or dual interface smart card 300, also referred to as a proximity integrated circuit card (PICC), is shown in FIG. 3, wherein emphasis is put on the arrangement of the booster antenna structure 310, also referred to as inductively coupled card coil (ICCC), and the CoM 320. Hence other elements commonly integrated in a chip card are omitted for reasons of clarity.

The circuit representing the booster antenna structure 310 includes a series arrangement of a voltage source 312, a booster antenna resistor 314, a booster antenna capacitor 316 and the booster antenna structure's coil 318 itself. The booster antenna structure may be seen to form a resonant circuit. The voltage source 312 represents the energy which is received by the smart card 300 from a reader (also referred to as proximity coupling device (PCD), not shown in FIG. 3) via the booster antenna structure 310 through electromagnetic waves which induce a voltage (U_{ind}) within the booster antenna structure 310 during operation.

The circuit representing the CoM 320 includes a chip card module coil 322, a chip card module resistor 324 and a chip card module capacitor 326 which are all coupled in parallel.

In this equivalent circuit, the chip 408 as shown in FIG. 4, is modelled by the chip card module resistor 324 and the chip module capacitor 326, the ohmic loss of the chip module resistor 324 representing the power consumption of the chip 408. The booster antenna structure 402, as shown in FIG. 4, is modelled by the resonance circuit in the form of a series circuit including the booster antenna resistor 314, the booster antenna capacitor 316 and the booster antenna structure coil 318 itself. The booster antenna resistor 314 models the ohmic resistance of the booster antenna coil 102. The ohmic resistance of the booster antenna coil 102 may be adjusted to a certain ohmic value by choosing the material composition of the booster antenna coil 102 and/or its dimensions, i.e. its width or diameter. The two entities, i.e. the booster antenna structure 310 according to various embodiments and the CoM 320, may couple with each other inductively. An arrow 328 denotes the magnetic coupling between the booster antenna structure 310 and the CoM 320, which takes place via the respective coil antenna of each of the entities. k_{BM} denotes the corresponding coupling coefficient.

The smart card 300 including the booster antenna structure 310 according to various embodiments may meet the requirements of relevant performance standards for smart cards such as EMVCo or ISO/IEC 10373-6. This may be achieved by optimizing the power transfer between a reader (not shown in FIG. 3) and the chip card 300 by selectively adjusting the booster antenna structure 310 according to various embodiments to the smart card chip module 320. Optimizing the power transfer may involve several aspects. Firstly, the operating frequency of the CoM resonance circuit 320 may be adjusted such that it corresponds to the operating frequency of the chip, e.g. to 13.56 MHz. The resonance frequency of the CoM resonance circuit may be adjusted, for example, by adjusting the CoM antenna's inductance with respect to the input capacitance of the chip. The resonance frequency of the booster antenna structure 310 may be set to the operating frequency of the chip, for example 13.56 MHz, by practically the same means as in the case of the CoM resonance frequency and/or by adding at least one further inductor and/or capacitor. Further, the quality factor of the booster antenna structure 310 may adjusted by providing additional electrically conductive structure (e.g. a resistor). By adjusting the quality factor of the booster antenna structure 310 the feedback effect of the booster antenna structure 310 on a reader (not shown in FIG. 3) may be limited to a maximum feedback effect which is allowable according to EMVCo standards, for example. All in all the booster antenna structure according to various embodiments may be customized for various smart card applications such that relevant standards for contactless systems may be complied with.

The booster antenna structures according to various embodiments discussed so far may be manufactured using several different techniques. The conducting structure forming the coil may be, for example, etched, wire-embedded or a print-and-plate manufacturing technology may be used. However, the manufacturing process is not to be seen as being limited to the mentioned manufacturing processes.

In various embodiments, a booster antenna structure is provided. The booster antenna structure may include a chip coupling region; a coil having a conductor forming multiple windings; wherein the coil encloses the chip coupling region substantially completely, wherein the conductor is arranged around the chip coupling region in a crossover-free manner.

In various embodiments, the chip coupling region may be configured to inductively couple to a coil which is arranged on a chip package, wherein the chip package is arranged in the chip coupling region. In various embodiments, the coil may include 2 to 10 windings, e.g. 2 to 5 windings. In various embodiments, the chip coupling region may have a size which, in a first dimension, extends from about 1 millimeter to about 20 millimeters and, in a second dimension, extends from about 1 millimeter to about 20 millimeters. In various embodiments, the booster antenna structure may further include a capacitor which is electrically coupled with the coil. In various embodiments, parts of the coil which enclose the chip coupling region may be arranged such that they permit a current flow which is oriented in a uniform direction, such that magnetic fields generated by the current flow through those parts of the coil add to one another thereby amplifying each other during operation of the booster antenna structure. In various embodiments, the conductor may include a correspondingly etched metallic layer with a line width in the range from about 50 μm to about 250 μm, for example in the range from about 150 μm to about 250 μm. In various embodiments, the conductor may include a wire with a diameter in the range from 60 μm to 100 μm. In various embodiments, the booster antenna structure may further include a carrier on which the coil is arranged. In various embodiments, the windings of the coil may be arranged on one side of the carrier. In various embodiments, the windings of the coil may be arranged on both sides of the carrier. In various embodiments, the capacitor may include a line capacitor. In various embodiments, parts of the capacitor may be arranged on both sides of the carrier.

In various embodiments, a chip card is provided. The chip card may include a booster antenna structure. The booster antenna structure may include a chip coupling region; a coil having a conductor forming multiple windings; wherein the coil encloses the chip coupling region substantially completely, wherein the conductor is arranged around the chip coupling region in a crossover-free manner.

In various embodiments, the chip coupling region may be configured to inductively couple to a coil which is arranged on a chip package, wherein the chip package is arranged in the chip coupling region. In various embodiments, the coil may include 2 to 10 windings, e.g. 2 to 5 windings. In various embodiments, the chip coupling region may have a size which, in a first dimension, extends from about 1 millimeter to about 20 millimeters and, in a second dimension, extends from about 1 millimeter to 20 millimeters. In various embodiments, the chip card may further include a capacitor which is electrically coupled with the coil. In various embodiments, parts of the coil which enclose the chip coupling region may be arranged such that they permit a current flow which is oriented in a uniform direction, such that magnetic fields generated by the current flow through those parts of the coil add to one another thereby amplifying each other during operation of the booster antenna structure. In various embodiments, the conductor may include a correspondingly etched metallic layer with a line width in the range from about 50 μm to about 250 μm, for example from about 150 μm to 250 μm. In various embodiments, the conductor may include a wire with a diameter in the range from 60 μm to 100 μm. In various embodiments, the chip card may further include a carrier on which the coil is arranged. In various embodiments, the windings of the coil may be arranged on one side of the carrier. In various embodiments, the windings of the coil may be arranged on both sides of the carrier. In various embodiments, parts of the capacitor may be arranged on both sides of the carrier.

In accordance with various further embodiments, a booster antenna structure is provided, the booster antenna structure including a coil having a conductor forming multiple windings; a chip coupling region substantially completely enclosed by a part of the coil along four sides of the chip coupling region, wherein the part of the coil substantially completely encloses the chip coupling region in a crossover-free manner such that on at least one side of the chip coupling region there is a passage between an inside and an outside of the chip coupling region.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A booster antenna structure comprising:
a chip coupling region;
a coil having a conductor forming multiple windings;
wherein the coil encloses the chip coupling region substantially completely,
wherein the conductor is arranged around the chip coupling region in a crossover-free manner.

2. The booster antenna structure of claim 1,
wherein the chip coupling region is configured to inductively couple to a coil which is arranged on a chip package, wherein the chip package is arranged in the chip coupling region.

3. The booster antenna structure of claim 1,
wherein the chip coupling region has a size which, in a first dimension, extends from 1 millimeter to 20 millimeters and, in a second dimension, extends from 1 millimeter to 20 millimeters.

4. The booster antenna structure of claim 1, further comprising:
a capacitor which is electrically coupled with the coil.

5. The booster antenna structure of claim 1,
wherein parts of the coil which enclose the chip coupling region are arranged such that they permit a current flow which is oriented in a uniform direction, such that magnetic fields generated by the current flow through those parts of the coil add to one another thereby amplifying each other during operation of the booster antenna structure.

6. The booster antenna structure of claim 4, further comprising:
a carrier on which the coil is arranged.

7. The booster antenna structure of claim 6,
wherein the windings of the coil are arranged on one side of the carrier.

8. The booster antenna structure of claim 6,
wherein the windings of the coil are arranged on both sides of the carrier.

9. The booster antenna structure of claim 6,
wherein the capacitor comprises a line capacitor.

10. The booster antenna structure of claim 6,
wherein parts of the capacitor are arranged on both sides of the carrier.

11. A chip card, comprising:
a booster antenna structure comprising:
a chip coupling region;
a coil having a conductor forming multiple windings;
wherein the coil encloses the chip coupling region substantially completely, wherein the conductor is arranged around the chip coupling region in a crossover-free manner.

12. The chip card of claim 11,
wherein the chip coupling region is configured to inductively couple to a coil which is arranged on a chip package, wherein the chip package is arranged in the chip coupling region.

13. The chip card of claim 11,
wherein the chip coupling region has a size which, in a first dimension, extends from 1 millimeter to 20 millimeters and, in a second dimension, extends from 1 millimeter to 20 millimeters.

14. The chip card of claim 11, further comprising:
a capacitor which is electrically coupled with the coil.

15. The chip card of claim 11,
wherein parts of the coil which enclose the chip coupling region are arranged such that they permit a current flow which is oriented in a uniform direction, such that magnetic fields generated by the current flow through those parts of the coil add to one another thereby amplifying each other during operation of the booster antenna structure.

16. The chip card of 14, further comprising:
a carrier on which the coil is arranged.

17. The chip card of claim 16,
wherein the windings of the coil are arranged on one side of the carrier.

18. The chip card of claim 16,
wherein the windings of the coil are arranged on both sides of the carrier.

19. The chip card of claim 16,
wherein parts of the capacitor are arranged on both sides of the carrier.

20. A booster antenna structure comprising:
a coil having a conductor forming multiple windings;
a chip coupling region substantially completely enclosed by a part of the coil along four sides of the chip coupling region;
wherein the part of the coil substantially completely encloses the chip coupling region in a crossover-free manner such that on at least one side of the chip coupling region there is a passage between an inside and an outside of the chip coupling region.
